(19) United States
(12) Patent Application Publication
(10) Pub. No.: US 2008/0060587 A1
(43) Pub. Date: Mar. 13, 2008

(54) Bird blinder apparatus

(76) Inventor: Jeffrey E. Tate, Hardinsburg, KY (US)

Correspondence Address: S. Michael Bender, P.O. Box 530-399, St. Petersburg, FL, 33747, US

(21) Appl. No.: 11/899,439

(22) Filed: Sep. 6, 2007

Related U.S. Application Data
(60) Provisional application No. 60/842,829, filed on Sep. 8, 2006.

(51) Int. Cl. A01K 37/00

(52) U.S. Cl. 119/715

(57) ABSTRACT

A bird blinder apparatus includes a blinder member for blocking views from eyes of a bird. A support member is connected to the blinder member for supporting the blinder member. The support member includes lock-member-reception channels. Flexible lock-member support arms are connected to the support member, and lock members are connected to the flexible lock-member support arms. The lock members include nostril entry ends. The lock members are received in the lock-member-reception channels, and the nostril entry ends extend into nostrils in the beak of the bird for locking the bird blinder apparatus onto the beak of the bird. The bird blinder apparatus of the invention provides a one-piece device that can be installed on the beak of a bird, by one hand of a user, without the need for a separate locking ring and without the need for a separate installation tool.

### CROSS-REFERENCE TO RELATED APPLICATION

This application claims priority based upon my copending Provisional Application Ser. No. 60/842,829; filed Sep. 8, 2006.

### BACKGROUND OF THE INVENTION

1. Field of the Invention

The present invention relates generally to bird blinder apparatuses and, more particularly, to bird blinder apparatuses that are connected to the nostrils of the bird.

2. Description of the Prior Art

Bird blinder apparatuses are well known in the art. In fact, FIGS. 1 and 2 herein illustrate one type of PRIOR ART bird blinder apparatus in which a separate and distinct attachment pin is used to connect the bird blinder apparatus to the nostrils of the bird.

In addition, throughout the years, additional devices been developed relating to bird blinder apparatuses, and the following U.S. patent is representative of some of those additional devices: U.S. Pat. No. 2,079,107. More specifically, U.S. Pat. No. 2,079,107 discloses a pair of blinders that is attached to the nostrils of the top beak of a chicken. With the chicken wearing the blinders, the chicken will be less prone to pecking at other chickens. A separate and distinct attachment pin is used to attach the blinders to the nostrils on the top beak of the chicken.

A number of problems are related to using a separate and distinct attachment pin to connect the bird blinder apparatus to the nostrils of the bird. One problem relates to the attachment pin itself. It is small and easily lost, misplaced, or dropped. Another problem relates to the need to employ a separate and distinct installation tool to connect and secure the attachment of the bird blinder apparatus to the nostrils of the bird.

Considering the problems related to using a separate and distinct attachment pin to connect the bird blinder apparatus to the nostrils of the bird, it would be desirable if a bird blinder apparatus were provided that does not employ a separate and distinct attachment pin to connect the bird blinder apparatus to the nostrils of the bird. Also, it would be desirable if a bird blinder apparatus were provided that does not need a separate and distinct installation tool to connect and secure the attachment of the bird blinder apparatus to the nostrils of the bird.

In this respect, it would be desirable if a bird blinder apparatus were provided which includes nostril attachment means that are integral with the bird blinder means.

In addition, the following U.S. patents may be of interest for their disclosure of some additional devices attached to the nostrils of the beak of a bird: U.S. Pat. Nos. 2,018,796, 3,704,689, and 5,836,267.

More specifically, U.S. Pat. No. 2,018,796 discloses protective head gear for chickens. A separate and distinct attachment pin is used to attach the headgear to the nostrils on the top beak of the chicken.

U.S. Pat. No. 3,704,689 discloses a poultry beak appliance that is attached to the top beak of the poultry. A separate and distinct attachment pin is used for attaching the beak appliance to the nostrils on the top beak of the poultry. The appliance is used to aid poultry in escaping from a wire screen when caught therein.

U.S. Pat. No. 5,836,267 discloses an anti-pecking device that is fitted to the beak of a bird. The device includes portions that fit into the nostrils of the bird to secure the device to the bird's beak. The remainder of the device fits onto the bird's beak so that the bird's beak is prevented from pecking other birds. Nothing in the device restricts the bird's field of vision.

Also, U.S. Pat. No. 1,877,897 may be of interest for its disclosure of a device for preventing feather pulling in fowls. The device slides onto the top beak of a fowl. The device does not block the vision of the fowl and does not attach to the nostrils of the fowl.

Thus, while the foregoing body of prior art indicates it to be well known to use bird blinder apparatuses, the prior art described above does not teach or suggest a bird blinder apparatus which has the following combination of desirable features: (1) does not employ a separate and distinct attachment pin to connect the bird blinder apparatus to the nostrils of the bird; (2) does not need a separate and distinct installation tool to connect and secure the attachment of the bird blinder apparatus to the nostrils of the bird; and (3) includes nostril attachment means that are integral with the bird blinder means.

The foregoing desired characteristics are provided by the unique bird blinder apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a bird blinder apparatus which includes a blinder member for blocking views from eyes of a bird. A support member is connected to the blinder member for supporting the blinder member. The support member includes lock-member-reception channels. Flexible lock-member support arms are connected to the support member, and lock members are connected to the flexible lock-member support arms. The lock members include nostril entry ends. The lock members are received in the lock-member-reception channels, and the nostril entry ends extend into nostrils in the beak of the bird for locking the bird blinder apparatus onto the beak of the bird. The bird blinder apparatus of the invention provides a one-piece device that can be installed on the beak of a bird, by one hand of a user, without the need for a separate locking ring and without the need for a separate installation tool.

Preferably, the support member includes straddle beams which straddle the beak when the bird blinder apparatus is installed on beak, and the lock-member-reception channels are located in the straddle beams.

Preferably, each of the lock members includes a nostril entry end, and a locking member bump is located between a respective nostril entry end and the respective straddle beam to which the lock member is connected.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved bird blinder apparatus which has all of the advantages of the prior art and none of the disadvantages.

It is another object of the present invention to provide a new and improved bird blinder apparatus which may be easily and efficiently manufactured and marketed.

It is a further object of the present invention to provide a new and improved bird blinder apparatus which is of durable and reliable construction.

An even further object of the present invention is to provide a new and improved bird blinder apparatus which is susceptible of a low cost of manufacture with regard to both materials and labor, and which accordingly is then susceptible of low prices of sale to the consuming public, thereby making such bird blinder apparatus available to the buying public.

Still yet a further object of the present invention is to provide a new and improved bird blinder apparatus which does not employ a separate and distinct attachment pin to connect the bird blinder apparatus to the nostrils of the bird.

Still another object of the present invention is to provide a new and improved bird blinder apparatus that does not need a separate and distinct installation tool to connect and secure the attachment of the bird blinder apparatus to the nostrils of the bird.

Yet another object of the present invention is to provide a new and improved bird blinder apparatus which includes nostril attachment means that are integral with the bird blinder means.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a perspective view showing a PRIOR ART bird blinder device being installed on the beak of a pheasant.

FIG. 2 is an exploded view of a PRIOR ART bird blinder device and an installation tool and a locking ring used for installing the PRIOR ART bird blinder device shown in FIG. 1.

FIG. 3 is a perspective view of a preferred embodiment of the bird blinder apparatus of the invention that has been installed on the beak of a pheasant.

FIG. 4 is a perspective view of the embodiment of the invention shown in FIG. 3 that has been removed from the beak of the pheasant.

FIG. 5 is top view of the embodiment of the invention shown in FIGS. 3 and 4.

FIG. 6 is a side view of the embodiment of the invention shown in FIG. 5, taken along line 6-6 thereof.

### DESCRIPTION OF THE PREFERRED EMBODIMENT

With reference to the drawings, a new and improved bird blinder apparatus embodying the principles and concepts of the present invention will be described.

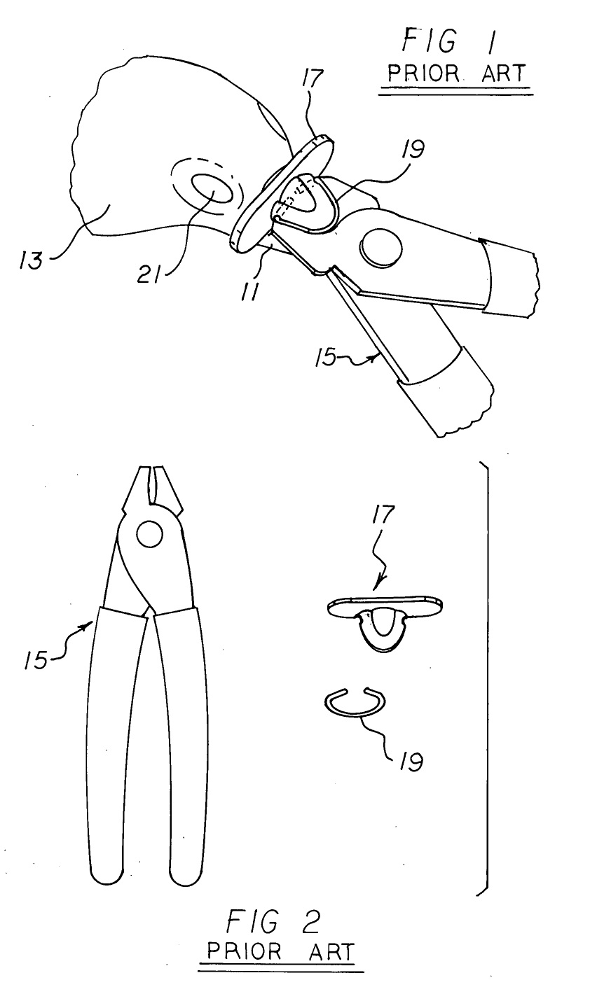

Turning to FIGS. 1 and 2, a PRIOR ART bird blinder device is shown.

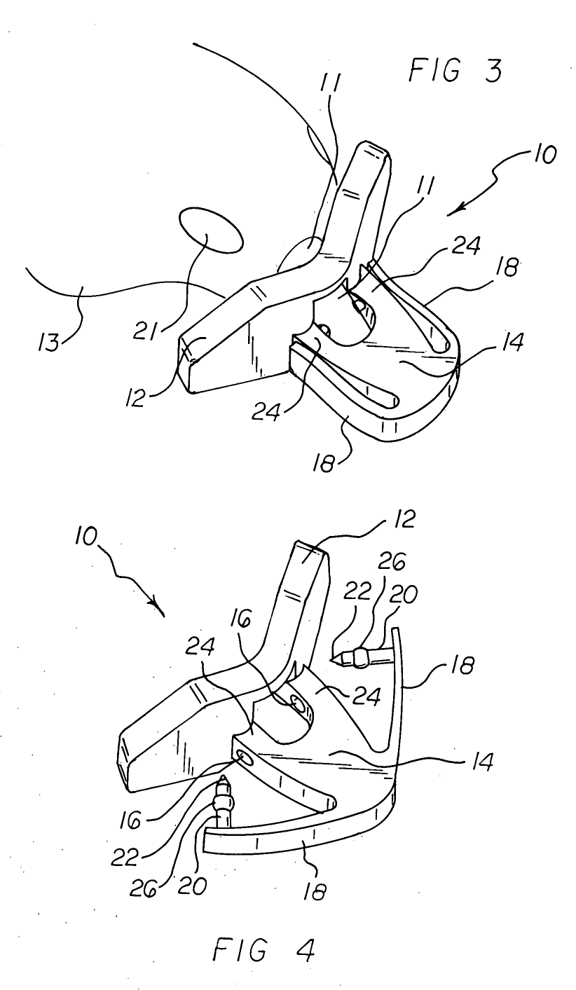

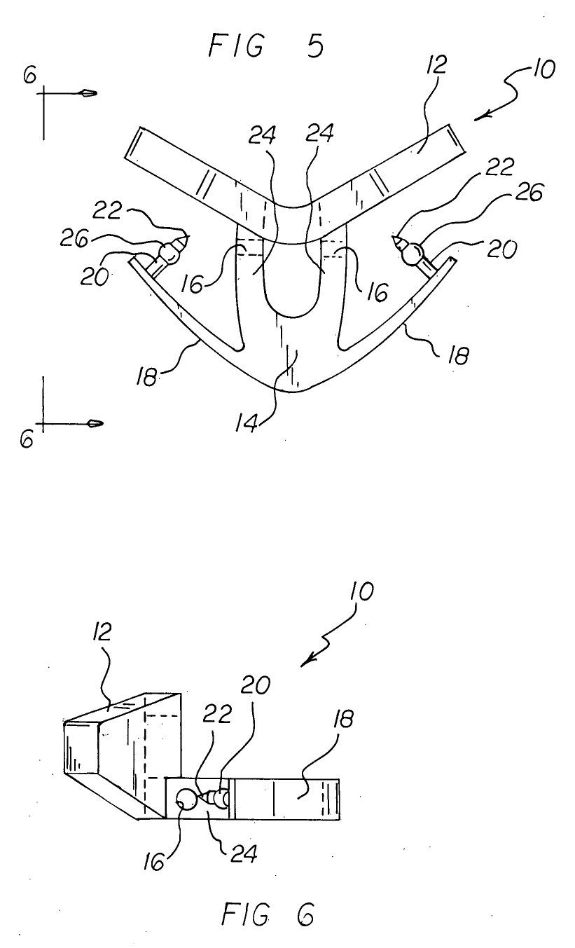

Turning to FIGS. 3-6, there is shown a preferred embodiment of the bird blinder apparatus of the invention generally designated by reference numeral 10. In each of the figures, reference numerals are shown that correspond to like reference numerals that designate like elements shown in other figures.

In the preferred embodiment, bird blinder apparatus 10 includes a blinder member 12 for blocking views from eyes of a bird. A support member 14 is connected to the blinder member 12 for supporting the blinder member 12. The support member 14 includes lock-member-reception channels 16. Flexible lock-member support arms 18 are connected to the support member 14, and lock members 20 are connected to the flexible lock-member support arms 18. The lock members 20 include nostril entry ends 22. The lock members 20 are received in the lock-member-reception channels 16, and the nostril entry ends 22 extend into nostrils in the beak 11 of the bird for locking the bird blinder apparatus 10 onto the beak 11 of the bird.

Preferably, the support member 14 includes straddle beams 24 which straddle the beak 11 when the bird blinder apparatus 10 is installed on beak 11, and the lock-member-reception channels 16 are located in the straddle beams 24.

Preferably, each of the lock members 20 includes a nostril entry end 22, and a locking member bump 26 is located between a respective nostril entry end 22 and the respective straddle beam 24 to which the lock member 20 is connected.

It is well known that when many birds are kept in close quarters, such birds tend to peck and harm one another. Birds are often kept in close quarters on farms which raise birds, such as farms which raise pheasants. It is also well known that temporary blocking the vision of those birds with a blinder or a peeper helps reduce the harmful pecking interaction between the birds. These principles of crowding and temporary vision blocking are well known when pheasants are crowded together.

The PRIOR ART bird blinder device shown in FIGS. 1 and 2 has a number of significant advantages. The bird blinder device 17 and the locking ring 19 are two separate and independent elements. In addition. A pliers-like installation tool 15 must be used to deform the locking ring 19 to be received in corresponding reception channels in the bird blinder device 17.

In contrast, the bird blinder apparatus 10 of the invention is a one-piece device that can installed on a beak 11 of a bird without the need for any kind of installation tool 15.

More specifically, as shown in FIG. 3, the bird blinder apparatus 10 of the invention is placed by a user on a bird beak 11 so that the straddle beams 24 straddle the beak 11 and so that the blinder member 12 blocks the vision of the eyes 21 of the bird. The bird can be a pheasant 13. Then, the straddle beams 24 are placed on the beak 11 so that the lock-member-reception channels 16 on the straddle beams 24 are placed in registration with the nostrils on the beak 11. Then, the user employs one's fingers to squeeze the flexible lock-member support arms 18 toward each other. As this is done, the lock members 20 pass into the lock-member-reception channels 16, and the nostril entry ends 22 of the lock members 20 enter the nostrils on the beak 11 of the bird. Also, the locking member bumps 26 on the lock members 20 serve to lock the lock members 20 with respect to the straddle beams 24. In this way, with a one-piece apparatus and without the use of an installation tool. A user, with a one-hand operation, can install a bird blinder apparatus 10 of the invention on the beak 11 of a bird by securing the apparatus to the nostrils on the beak 11 of the bird.

When the bird blinder apparatus 10 of the invention is to be removed from the beak 11 of the bird, the user pulls on the flexible lock-member support arms 18 to pull the lock members 20 out from the bird's nostrils and out from the lock-member-reception channels 16 on the straddle beams 24. Then, the bird blinder apparatus 10 can be removed from the beak 11 of the bird.

The components of the bird blinder apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved bird blinder apparatus that is low in cost, relatively simple in design and operation, and which may advantageously be used without employing a separate and distinct attachment pin to connect the bird blinder apparatus to the nostrils of the bird. With the invention, a bird blinder apparatus is provided which does not need a separate and distinct installation tool to connect and secure the attachment of the bird blinder apparatus to the nostrils of the bird. With the invention, a bird blinder apparatus is provided which includes nostril attachment means that are integral with the bird blinder means.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A bird blinder apparatus, comprising:
a blinder member for blocking views from eyes of a bird,
a support member connected to said blinder member for supporting said blinder member, wherein said support member includes lock-member-reception channels,
flexible lock member support arms connected to said support member, and
lock members connected to said flexible lock member support arms, wherein said lock members include nostril entry ends, wherein said lock members are received in said lock-member-reception channels, and wherein said nostril entry ends extend into nostrils of the bird for locking the bird blinder apparatus onto the beak of the bird.

2. The apparatus of claim 1 wherein:
said support member includes straddle beams which straddle the beak when the bird blinder apparatus is installed on beak, and
said lock-member-reception channels are located in said straddle beams.

3. The apparatus of claim 2 wherein each of said lock members includes:
a nostril entry end, and
a locking member bump located between said nostril entry end and the respective straddle beam to which said lock member is connected.
